(19) United States
(12) Patent Application Publication
(10) Pub. No.: US 2004/0176264 A1
(43) Pub. Date: Sep. 9, 2004

(54) Rinse aid composition containing water-soluble metal salt for use in automatic dishwashing for glassware corrosion protection

(75) Inventors: Brian Xiaoqing Song, West Chester, OH (US); Marie Rose Salem, Cincinnati, OH (US); Paul Joseph Drzewiecki, Maineville, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/738,888

(22) Filed: Dec. 17, 2003

Related U.S. Application Data
(60) Provisional application No. 60/436,963, filed on Dec. 30, 2002.

(51) Int. Cl. C11D 1/66

(52) U.S. Cl. 510/227; 510/514

(57) ABSTRACT

a water-soluble metal salt, an acid, a non-ionic surfactant, a dispersant polymer and/or a perfume for use in automatic dishwashing is disclosed.

### CROSS REFERENCE TO RELATED APPLICATION

This application claims the benefit of the filing date of U.S. Patent Application No. 60/436,963, filed Dec. 30, 2002, the disclosure of which is incorporated by reference herein.

### FIELD OF THE INVENTION

The present invention is in the field of dishwashing, in particular it relates to automatic dishwashing products, auxiliaries and methods suitable for protecting glassware.

### BACKGROUND OF THE INVENTION

Odor, spotting, filming and corrosion of glassware in automatic dishwashing are well known problems that continually plague consumers. Consumers demand better end results. They desire better smelling products with less glassware spotting and filming. They want better shine with improved corrosion protection. Most consumers agree that corrosion of glassware in automatic dishwashing is one of their most serious unmet needs. Though when compared to over main wash detergent products alone, some current rinse aid products may deliver better spotting and filming performance with the use of dispersant polymers in combination with nonionic surfactants, they do not protect against glassware corrosion.

Compositions comprising water-soluble metal salts (such as zinc salts of chloride, sulfate or acetate) for use in dishwashing afford some measure of glassware protection. Water-soluble zinc salt may be employed to prevent the corrosion of ceramic surfaces. Solid metal plates of zinc alloys may also be used in combination with a detergent composition to provide corrosion protection to glassware. A water-soluble zinc salt may even be used in conjunction with a low-foaming nonionic surfactant in neutral to high pH. However, the use of this high pH composition in automatic dishwashing can result in unsatisfactory filming and precipitation of insoluble materials. Such precipitant material is very undesirable as it can adhere to internal dishwasher parts, as well as, onto dish- and glassware during the washing cycle. One alternative to reducing precipitate formation is achieved by carefully adjusting the levels and proportions of various components in product formulation. This method requires strict formulation controls and is costly. Another alternative to reduce precipitate formation is achieved by spraying a solution of the water-soluble zinc salt onto granular polyphosphate particles. Another alternative using soluble zinc and a chelant provides some glassware corrosion protection but has a filming negative (i.e. crystals and films formed on glassware). Yet another alternative is to use insoluble zinc salt to control the release of the zinc ion in the rinse to avoid filming. However, there are disadvantages of using insoluble materials in the liquid rinse aid formulations. The product would be cloudy and it requires particular thickeners and stabilizers which may hinder delivery of the product from the rinse aid dispenser to the rinse liquor.

It is surprisingly found that at pH below about 5 and without the use of a chelating agent, or alternatively without the use of a substantial amount of a chelating agent, a rinse aid composition containing water-soluble metal salt (in conjunction with specific components, such as non-ionic surfactants, dispersant polymers, perfumes, adjunct ingredients, and mixtures thereof) delivers consumers a better smelling product having an improved filming benefit on glassware while at the same time providing improved glassware corrosion protection without unwanted precipitation of insoluble materials on glassware. These metal salt containing rinse aid compositions not only smell better and at least partially reduce unwanted precipitation, they will also aid in reducing film formation. In fact, they also surprisingly exhibit even better filming performance on glassware than the prior art due to the presence of the water-soluble metal salt, the acid, and/or the combination of the acid and dispersant polymer together.

### SUMMARY OF THE INVENTION

A rinse aid composition containing a water-soluble metal salt, an acid, a non-ionic surfactant, a dispersant polymer and/or a perfume for use in automatic dishwashing is disclosed. In one non-limiting embodiment, a rinse aid composition for reducing glassware corrosion comprises: (a) at least one water-soluble metal salt; (b) an acid; (c) a non-ionic surfactant; (d) at least one of the following: a dispersant polymer, a perfume, and mixtures thereof; and (e) optionally at least one component selected from the group consisting of: an acid, a dispersant polymer, a perfume, a hydrotrope, a binder, a carrier medium, an antibacterial active, a dye, and mixtures thereof. The rinse aid composition has a pH of less than about 5 when measured at a 10% concentration in an aqueous solution. The rinse aid composition comprises an acid that enables the water-soluble metal salt to dissolve quickly in rinse liquor so as to eliminate formation of insoluble precipitates. In another non-limiting embodiment, a glassware corrosion and film formation prevention means for use in automatic dishwashing is disclosed, wherein the means comprises the step of rinsing cleaned glassware surfaces with a rinse aid composition as disclosed above. The use of the automatic dishwashing detergent composition in a method, and a kit are also disclosed herein.

### DETAILED DESCRIPTION OF THE DRAWINGS

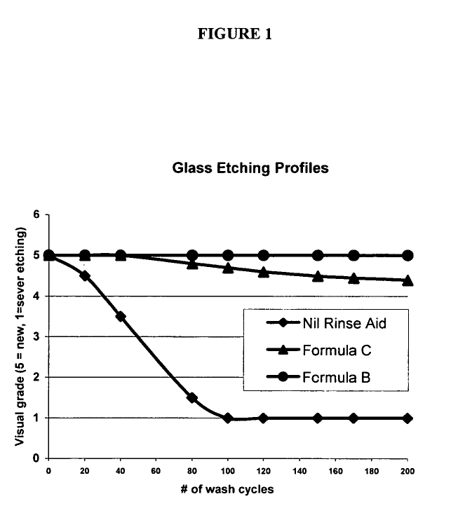

FIG. 1 depicts a graph showing glass-etching profiles as a function of visual grades versus number of wash cycles.

### DETAILED DESCRIPTION OF THE INVENTION

A rinse aid composition is disclosed herein which contains a water-soluble metal salt for use in an automatic dishwashing appliance. The rinse aid composition may improve glassware corrosion protection, as well as, filming performance without resulting in excessive precipitation in the wash and/or rinse liquor.

In FIG. 1, glass-etching profiles of three treatments are performed in soft water in a multi-cycle test using a GE500 automatic dishwashing appliance. CASCADE™ Pure Rinse Gel®, the main wash detergent, is dosed in the prewash and in the main wash as recommended. Three treatments are preformed: rinse aid formula B, rinse aid formula C and nil rinse aid. In treatments using the rinse aid, two (2) mls of rinse aid formulas B and C, respectively, are added to the final rinse of each wash cycle. A normal wash with heat dry cycle is run for all three treatments. The glasses are graded in a light box after 20, 40, 80, 100, 120, 150, 170 and 200 cycles. A grade of 5 is perfect (no visible etching in the light box), while a grade of 1 is evidence of severe etching. A grade of below about 3.5 is visible to a consumer under regular room lighting. From the data depicted in FIG. 1, it can be seen that the control formula (nil rinse aid) exhibits visible etching under regular lighting after about 40 washes. Though the rinse aid formula C exhibits slight etching (cloudiness) in the light box after 200 washes, it still exhibits no visible etching under regular lighting. Surprisingly however, formula B exhibits no etching even in the light box (still perfect) after 200 washes.

Formulating the water-soluble metal salt with an acid, either organic or inorganic, can eliminate precipitation. In the case of the liquid rinse aid composition, adding an acid to the rinse aid composition enables the water-soluble metal salt to fully dissolve in the rinse aid composition and thereby reduces the chances of precipitate formation on dish- and glassware during the rinse cycle. An acid may be added to the rinse aid composition to enable the water-soluble metal salt to dissolve quickly in the rinse liquor as so to keep insoluble material from forming and subsequently depositing onto glasses or dishes during the wash and/or rinse cycle. The addition of a water-soluble metal salt in the presence of an acid significantly improves filming performance on glassware. Surprisingly, the addition of a dispersant polymer to this metal salt/acid mixture further improves glassware filming performance. The addition of a perfume to the rinse aid composition improves the odor profile of the consumer rinse aid product before, as well as, during the operation of the automatic dishwasher.

The rinse aid composition may be in any suitable form, including liquid, gel, solid, granular, powder, and combinations thereof. The solid water-soluble metal salt may be in the form of a powder, crystal, core particle, aggregate of core particles, prill, agglomerate, and mixtures thereof. These solid forms may be nonfriable for handling purposes during processing and when used by consumers.

Any suitable water-soluble metal salt in any suitable amount may be used to make the rinse aid composition. In one non-limiting embodiment, water-soluble salts of at least one metal selected from the group consisting of aluminum, zinc, magnesium, calcium, lanthanum, tin, gallium, strontium, titanium, and mixtures thereof, may be used in the rinse aid composition.

The water-soluble metal salt can be used directly as the raw material in the rinse aid composition or it can be provided as an additive compound, which may be added along with other components to form the rinse aid composition.

The rinse aid composition may, for example, deliver any suitable amount of the water-soluble metal salt compound and/or product in the rinse liquor. For example, the rinse aid composition may deliver from about 0.01 mM to about 10 mM, alternatively about 0.02 mM to about 5 mM, alternatively about 0.05 mM to about 1 mM, and alternatively about 0.05 mM to about 0.5 mM of the water-soluble metal salt.

The rinse aid composition may be designed to deliver any suitable amount of metal ions in any suitable form in the rinse liquor of an automatic dishwashing appliance. For example, the rinse aid composition may be designed to deliver from about 0.1% to about 20%, alternatively from about 0.2% to about 15%, alternatively from about 0.5% to about 10%, and alternatively from about 1% to about 5% by weight of metal ions in the form of a water-soluble metal salt rinse aid composition and/or product in the rinse liquor of an automatic dishwashing appliance.

The water-soluble metal salt may, for example, be present in an amount from about 0.01% to about 70%, alternatively from about 0.1% to about 50%, alternatively from about 0.5% to about 30%, and alternatively from about 1% to about 10% by weight of the composition. In one non-limiting embodiment, a water-soluble metal salt may be present in an amount from about 0.01% to about 70% by weight of the rinse aid composition composition.

Zinc Salt

Any suitable water-soluble salt of zinc in any suitable amount may be used to make the rinse aid composition.

Suitable water-soluble zinc salts include, but are not limited to: zinc acetate, zinc benzoate, zinc borate, zinc bromide, zinc chloride, zinc formate, zinc gluconate, zinc lactate, zinc laurate, zinc malate, zinc nitrate, zinc perborate, zinc sulfate, zinc sulfamate, zinc tartrate, and mixtures thereof.

Water-soluble zinc salt can also be formed in-situ by reacting zinc oxide and an acid in rinse aid formulations. Any acid, organic or inorganic, that does not result in precipitation of the zinc salt in the composition after mixing can also be used. In one embodiment, a rinse aid composition may comprise a water-soluble zinc salt, which is prepared in-situ by mixing zinc oxide with an acid. For example, in the formulation of a liquid rinse aid composition, the components are mixed until all powder is dissolved to give a clear solution. After the in-situ neutralization process, other ingredients can be added into the liquid mixture to formulate a liquid rinse aid composition. In another example, a binder or a solid surfactant (e.g. solid at 25° C.) may be used to formulate the solid rinse aid composition.

In one non-limiting embodiment, the rinse aid composition may be designed to deliver from about 0.1% to about 20% by weight of Zn⁺⁺ ions in the form of a water-soluble zinc salt composition and/or product in the rinse liquor of an automatic dishwashing appliance. In another non-limiting embodiment, a water-soluble zinc salt may be present in an amount from about 0.01% to about 70% by weight of the rinse aid composition. In another non-limiting embodiment, the water-soluble zinc salt is used directly as the raw material in the rinse aid composition and/or provided as an additive compound or product that is added along with other components to form the rinse aid composition.

Aluminum Salt

Any suitable water-soluble salt of aluminum in any suitable amount may be used to make the rinse aid compositions.

Suitable water-soluble aluminum salts include, but are not limited to: aluminum acetate, aluminum ammonium sulfate, aluminum chlorate, aluminum chloride, aluminum chlorohydrate, aluminum diformate, aluminum formoacetate, aluminum monostearate, aluminum lactate, aluminum nitrate, aluminum sodium sulfate, aluminum sulfate, aluminum stearate, aluminum tartrate, aluminum triformate, and mixtures thereof.

In one non-limiting embodiment, the rinse aid composition may be designed to deliver from about 0.1% to about 20% by weight of Al⁺⁺⁺ ions in the form of a water-soluble aluminum salt composition and/or product in the rinse liquor of an automatic dishwashing appliance. In another non-limiting embodiment, a water-soluble aluminum salt may be present in an amount from about 0.01% to about 70% by weight of the composition. In another non-limiting embodiment, the water-soluble aluminum salt is used directly as the raw material in the rinse aid composition and/or provided as an additive compound or product that is added along with other components to form the rinse aid composition.

Magnesium Salt

Any suitable water-soluble salt of magnesium in any suitable amount may be used to make the rinse aid composition.

Water-soluble magnesium salts include, but are not limited to: magnesium acetate, magnesium acetylacetonate, magnesium ammonium phosphate, magnesium benzoate, magnesium biophosphate, magnesium borate, magnesium borocitrate, magnesium bromate, magnesium bromide, magnesium calcium chloride, magnesium chlorate, magnesium chloride, magnesium citrate, magnesium dichromate, magnesium fluosilicate, magnesium formate, magnesium gluconate, magnesium glycerophosphate, magnesium lauryl sulfate, magnesium nitrate, magnesium perchlorate, magnesium permanganate, magnesium salicylate, magnesium stannate, magnesium stannide, magnesium sulfate, and mixtures thereof.

In one non-limiting embodiment, the rinse aid composition may be designed to deliver from about 0.1% to about 20% by weight of Mg⁺⁺ ions in the form of a water-soluble magnesium salt composition and/or product in the rinse liquor of an automatic dishwashing appliance. In another non-limiting embodiment, a water-soluble magnesium salt may be present in an amount from about 0.01% to about 70% by weight of the composition. In another non-limiting embodiment, the water-soluble magnesium salt is used directly as the raw material in the rinse aid composition and/or provided as an additive compound or product that is added along with other components to form the rinse aid composition.

Calcium Salt

Any suitable water-soluble salt of calcium in any suitable amount may be used to make the rinse aid composition.

Water-soluble calcium salts include, but are not limited to: calcium acetate, calcium acetylsalicylate, calcium acrylate, calcium ascorbate, calcium borate, calcium bromate, calcium bromide, calcium chlorate, calcium chloride, calcium cyclamate, calcium dehydroacetate, calcium dichromate, calcium disodium edetate, calcium ethylhexoate, calcium formate, calcium gluconate, calcium iodate, calcium nitrite, calcium pantothenate, calcium perborate, calcium perchlorate, calcium permanganate, calcium propionate, calcium tartate, and calcium thiocynnate, and mixtures thereof.

In one non-limiting embodiment, the rinse aid composition may be designed to deliver from about 0.1% to about 20% by weight of Ca⁺⁺ ions in the form of a water-soluble calcium salt composition and/or product in the rinse liquor of an automatic dishwashing appliance. In another non-limiting embodiment, a water-soluble calcium salt may be present in an amount from about 0.01% to about 70% by weight of the composition. In another non-limiting embodiment, the water-soluble calcium salt is used directly as the raw material in the rinse aid composition and/or provided as an additive compound or product that is added along with other components to form the rinse aid composition.

Other Water-Soluble Metal Salts

Any other suitable water-soluble metal salt in any suitable amount may be used to make the rinse aid composition.

These other water-soluble metal salts may include at least one salt selected from the group consisting of lanthanum, tin, gallium, strontium, titanium, and combinations thereof which may be delivered and/or formulated to the rinse liquor in an automatic dishwashing appliance in the same amount as disclosed above.

In one non-limiting embodiment, the rinse aid composition may be designed to deliver from about 0.1% to about 20% by weight of these other metal ions in the form of an other water-soluble metal salt composition and/or product in the rinse liquor of an automatic dishwashing appliance. In another non-limiting embodiment, any other water-soluble metal salt may be present in an amount from about 0.01% to about 70% by weight of the composition. In another non-limiting embodiment, any other water-soluble metal salt is used directly as the raw material in the rinse aid composition and/or provided as an additive compound or product that is added along with other components to form the rinse aid composition.

Acid

Any suitable organic and/or inorganic acid in any suitable amount may be used in the rinse aid compositions and/or products. Some suitable acids include, but are not limited to: acetic acid, aspartic acid, benzoic acid, boric acid, bromic acid, citric acid, formic acid, gluconic acid, glutamic acid, hydrochloric acid, lactic acid, malic acid, nitric acid, sulfamic acid, sulfuric acid, tartaric acid, and mixtures thereof.

In the case of a liquid rinse aid composition, adding an acid to the rinse aid composition enables the water-soluble metal salt to at least partially dissolve, and alternatively to fully dissolve, in the composition. The acid also helps to at least partially reduce the precipitation on hard surfaces during the rinse cycle. The acid may be also needed to stabilize the liquid rinse aid composition against precipitation in the product prior to use.

In the case of a solid rinse aid composition, adding an acid to the rinse aid composition enables the water-soluble metal salt, once released, to at least partially dissolve, and alternatively to fully dissolve, quickly in the wash and/or rinse liquor of an automatic dishwashing appliance so as to prevent insoluble material from forming and/or from depositing onto hard surfaces, such as on flatware, glasses, dishes and/or components inside the automatic dishwashing appliance itself.

Acids used for in-situ preparation of water-soluble metal salts must be non-precipitating acids. Certain acids will not result in precipitation of the water-soluble metal salt in the rinse aid composition and/or product itself or in rinse liquor of the automatic dishwashing appliance during the rinse cycle. For example, nitric acid, hydrochloric acid, and mixtures thereof, are typically non-precipitation acids. Conversely, other acids, like phosphoric acid, citric acid, and mixtures thereof, are precipitating acids, which may result in precipitation of an insoluble metal salt in the rinse aid composition and/or product itself. These precipitating acids cannot be used in the in-situ water-soluble metal salt preparation process itself. However, a low level of a precipitating acid may be added after the completion of the in-situ water-soluble metal salt preparation process.

The amount of acid needed in the in-situ water-soluble metal salt preparation process may, for example, be determined stoichimetrically using the formula:

2 HₓA+XZnO→XZn A_{2/x}+XH₂O

wherein A is an organic and/or an inorganic acid, and x is an integer that varies from 1 to 2. Suitable acids are typically present in an rinse aid compositions and/or products in the range from about 0.01% to about 25%, alternatively from about 0.5% to about 20%, and alternatively from about 1% to about 10%, by weight of the composition.

In one non-limiting embodiment, an acid used in the in-situ water-soluble metal salt preparation process may be selected from the group consisting of acetic acid, formic acid, gluconic acid, glutamic acid, hydrochloric acid, malic acid, nitric acid, sulfuric acid, and mixtures thereof, by weight of the mixture may be used.

pH

The rinse aid composition may be formulated within any suitable acidic pH range. The pH is measured at a 10% concentration in an aqueous solution for any form of the rinse aid composition.

Suitable pHs range from about 1 to less than about 5, alternatively from about 1 to about 4, and alternatively from about 1 to about 3. A lower pH range will tend to reduce incompatibility and negative interaction of the rinse aid composition with existing commercial rinse aid product residues left in the rinse aid dispenser reservoir of the automatic dishwashing appliance prior to use.

In one non-limiting embodiment, the pH of the rinse aid composition may be in the range of from about 1 to less than about 5.

Nonionic Surfactant

Any suitable non-ionic surfactant in any suitable amount may be used to make the rinse aid composition. Suitable non-ionic surfactants include, but are not limited to, low foaming nonionic surfactants (LFNIs). LFNIs are most typically used in automatic dishwashing compositionss on account of the improved water-sheeting action (especially from glassware) which they confer to the rinse aide product. They also may encompass non-silicone, phosphate or nonphosphate polymeric materials further illustrated hereinafter which are known to defoam food soils encountered in automatic dishwashing.

In one non-limiting embodiment, an LFNI may include nonionic alkoxylated surfactants, especially ethoxylates derived from primary alcohols, and blends thereof with more sophisticated surfactants, such as the polyoxypropylene/polyoxyethylene/polyoxypropylene reverse block polymers. Suitable block polyoxyethylene-polyoxypropylene polymeric compounds that meet the requirements may include those based on ethylene glycol, propylene glycol, glycerol, trimethylolpropane and ethylenediamine, and mixtures thereof, as initiator reactive hydrogen compound. Polymeric compounds made from a sequential ethoxylation and propoxylation of initiator compounds with a single reactive hydrogen atom, such as C₁₂₋₁₈ aliphatic alcohols, do not generally provide satisfactory suds control in rinse aid compositions. However, certain of the block polymer surfactant compounds designated as PLURONIC® and TETRONIC® by the BASF-Wyandotte Corp., Wyandotte, Mich., are suitable in rinse aide compositions.

In another non-limiting embodiment, the LFNI may contain from about 40% to about 70% of a polyoxypropylene/polyoxyethylene/polyoxypropylene block polymer blend comprising about 75%, by weight of the blend, of a reverse block co-polymer of polyoxyethylene and polyoxypropylene containing 17 moles of ethylene oxide and 44 moles of propylene oxide; and about 25%, by weight of the blend, of a block co-polymer of polyoxyethylene and polyoxypropylene initiated with trimethylolpropane and containing 99 moles of propylene oxide and 24 moles of ethylene oxide per mole of trimethylolpropane.

In another non-limiting embodiment, the rinse aid composition may include the use of ethoxylated monohydroxy alcohol or alkyl phenol and additionally comprise a polyoxyethylene, polyoxypropylene block polymeric compound; the ethoxylated monohydroxy alcohol or alkyl phenol fraction of the LFNI comprising from about 20% to about 80%, alternatively from about 30% to about 70%, of the total LFNI.

The LFNI can optionally contain propylene oxide in an amount up to about 15% by weight. Other alternative LFNI surfactants can be prepared by the processes described in U.S. Pat. No. 4,223,163, issued Sep. 16, 1980, Builloty.

The LFNI may be an ethoxylated surfactant derived from the reaction of a monohydroxy alcohol or alkylphenol containing from about 8 to about 20 carbon atoms, excluding cyclic carbon atoms, with from about 6 to about 15 moles of ethylene oxide per mole of alcohol or alkyl phenol on an average basis.

The LFNI may be derived from a straight chain fatty alcohol containing from about 16 to about 20 carbon atoms (C₁₆-C₂₀ alcohol), alternatively a C₁₈ alcohol, condensed with an average of from about 6 to about 15 moles, alternatively from about 7 to about 12 moles, and alternatively from about 7 to about 9 moles of ethylene oxide per mole of alcohol. Alternatively the ethoxylated nonionic surfactant so derived has a narrow ethoxylate distribution relative to the average.

Suitable for use as an LFNI in the rinse aid compositions are those LFNIs having relatively low cloud points and high hydrophilic-lipophilic balance (HLB). Cloud points of 1% solutions in water are typically below about 32° C. and alternatively lower, e.g., 0° C., for optimum control of sudsing throughout a full range of water temperatures.

An LFNI may, for example, be present in an amount in the range of from about 0.01% to about 60% by weight, alternatively from about 0.01% to about 50%, and alternatively from about 0.01% to about 40% by weight of the rinse aid composition.

In one non-limiting embodiment, the rinse aid composition comprises from about 0.01% to about 60% by weight of the composition of a low-foaming nonionic surfactant having a cloud point below 30° C. In another non-limiting embodiment, the surfactant may be a low cloud point nonionic surfactant selected from the group consisting of C_{9/11}EO₈-cyclohexyl acetal alkyl capped nonionic, C₁₁EO₇-butyl acetal, C_{9/11}EO₈-2-ethylhexyl acetal, C₁₁EO₈-pyranyl, alcohol alkoxylate, and mixtures thereof.

In another non-limiting embodiment, the LFNI may include a C₁₈ alcohol polyethoxylate, having a degree of ethoxylation of about 8, commercially available SLF18® from Olin Corp™. Any biodegradable LFNI having the melting point properties discussed herein above, and mixtures thereof.

Dispersant Polymer

Any suitable dispersant polymer in any suitable amount may be used to make the rinse aid composition. Dispersant polymers are useful in rinse aid compositions because they provide improved filming performance, improved surface wetting, and improved particulate suspension and/or dispersion.

Suitable polymers are described in U.S. Pat. No. 4,379,080 (Murphy), issued Apr. 5, 1983. These polymers inhibit the deposition of calcium carbonate or magnesium silicate on dishware. Other suitable dispersant polymers include those disclosed in U.S. Pat. No. 3,308,067 issued Mar. 7, 1967, to Diehl. Other suitable dispersant polymers include those disclosed in U.S. Pat. No. 3,308,067 issued Mar. 7, 1967, to Diehl. Unsaturated monomeric acids that can be polymerized to form suitable dispersant polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. may be suitable provided that such segments do not constitute more than about 50% by weight of the dispersant polymer.

In one non-limiting embodiment, the rinse aid composition may include a dispersant polymer comprising one or more homopolymer, copolymer, terpolymer, and mixtures thereof.

Substantially non-neutralized forms of the polymer may be used in the rinse aid compositions. The molecular weight of the polymer can vary over a wide range, for instance from about 1000 to about 500,000, alternatively from about 1000 to about 250,000. If the rinse aid composition is for use in North American automatic dishwashing appliances, it may be desirable for the molecular weight of the polymer to range from about 1000 to about 5,000.

Copolymers of acrylamide and acrylate having a molecular weight of from about 3,000 to about 100,000, alternatively from about 4,000 to about 20,000, and an acrylamide content of less than about 50%, alternatively less than about 20%, by weight of the dispersant polymer can also be used. Alternatively, such dispersant polymer may have a molecular weight of from about 4,000 to about 20,000 and an acrylamide content of from about 0% to about 15%, by weight of the polymer.

In another non-limiting embodiment, the dispersant polymer may be a low molecular weight modified polyacrylate copolymer. Such copolymers contain as monomer units: a) from about 90% to about 10%, alternatively from about 80% to about 20% by weight acrylic acid or its salts and b) from about 10% to about 90%, alternatively from about 20% to about 80% by weight of a substituted acrylic monomer or its salt and have the general formula:

—[(C(R²)C(R¹)(C(O)OR³)]—

wherein the incomplete valencies inside the square braces are hydrogen and at least one of the substituents R¹, R² or R³, alternatively R¹ or R², is a 1 to 4 carbon alkyl or hydroxyalkyl group, R¹ or R² can be a hydrogen and R³ can be a hydrogen or alkali metal salt. In one alternative, a substituted acrylic monomer may be used wherein R¹ is methyl, R² is hydrogen and R³ is sodium.

The low molecular weight polyacrylate dispersant polymer alternatively has a molecular weight of less than about 15,000, alternatively from about 500 to about 10,000, alternatively from about 1,000 to about 5,000. Alternatively, the polyacrylate copolymer for use herein may have a molecular weight of 3500 and is the non-neutralized form of the polymer comprising about 70% by weight acrylic acid and about 30% by weight methacrylic acid.

Other suitable modified polyacrylate copolymers include the low molecular weight copolymers of unsaturated aliphatic carboxylic acids disclosed in U.S. Pat. Nos. 4,530,766, and 5,084,535.

In another non-limiting embodiment, the dispersant polymers may also include polyacrylates with an average molecular weight of from about 1,000 to about 10,000, and acrylate/maleate or acrylate/fumarate copolymers with an average molecular weight of from about 2,000 to about 80,000 and a ratio of acrylate to maleate or fumarate segments of from about 30:1 to about 1:2. Examples of such copolymers based on a mixture of unsaturated mono- and dicarboxylate monomers are disclosed in European Patent Application No. 66,915, published Dec. 15, 1982.

In another non-limiting embodiment, the dispersant polymers useful herein may include the polyethylene glycols and polypropylene glycols having a molecular weight of from about 950 to about 30,000 which can be obtained from the Dow Chemical Company of Midland, Mich. Such compounds for example, having a melting point within the range of from about 30° C. to about 100° C. can be obtained at molecular weights of 1450, 3400, 4500, 6000, 7400, 9500, and 20,000. Such compounds are formed by the polymerization of ethylene glycol or propylene glycol with the requisite number of moles of ethylene or propylene oxide to provide the desired molecular weight and melting point of the respective and polypropylene glycol. The polyethylene, polypropylene and mixed glycols are referred to using the formula:

HO(CH₂CH₂O)ₘ(CH₂CH(CH₃)O)ₙ(CH(CH₃)CH₂O)OH

wherein m, n, and o are integers satisfying the molecular weight and temperature requirements given above.

In another non-limiting embodiment, the dispersant polymers useful herein may include the cellulose sulfate esters such as cellulose acetate sulfate, cellulose sulfate, hydroxyethyl cellulose sulfate, methylcellulose sulfate, hydroxypropylcellulose sulfate, and mixtures thereof. Sodium cellulose sulfate may be used as an alternative.

In another non-limiting embodiment, the cellulose-derived dispersant polymer may be a carboxymethyl cellulose. In another non-limiting embodiment, the dispersant polymer may be an organic dispersant polymer, such as polyaspartate.

Other suitable dispersant polymers are the carboxylated polysaccharides, particularly starches, celluloses and alginates, described in U.S. Pat. No. 3,723,322, Diehl, issued Mar. 27, 1973; the dextrin esters of polycarboxylic acids disclosed in U.S. Pat. No. 3,929,107, Thompson, issued Nov. 11, 1975; the hydroxyalkyl starch ethers, starch esters, oxidized starches, dextrins and starch hydrolysates described in U.S. Pat. No. 3,803,285, Jensen, issued Apr. 9, 1974; the carboxylated starches described in U.S. Pat. No. 3,629,121, Eldib, issued Dec. 21, 1971; and the dextrin starches described in U.S. Pat. No. 4,141,841, McDanald, issued Feb. 27, 1979.

When present, a dispersant polymer in the rinse aid composition is compatible with other components. A dispersant polymer may, for example, be present in an amount in the range from about 0.01% to about 25%, alternatively from about 0.5% to about 20%, and alternatively from about 1% to about 7% by weight of the rinse aid composition.

Perfume

Any suitable perfume in any suitable amount may be used to make the rinse aid composition. Perfumes are useful for improved odor profiles of the water-soluble metal salt containing rinse aid composition, as well as, during the automatic dishwashing operation.

A perfume may, for example, be present in an amount from about 0.01% to about 5%, alternatively from about 0.1% to about 3%, and alternatively from about 0.1% to about 2% of a perfume composition. Suitable perfumes used in this rinse aid composition may be classified as non-blooming as well as blooming perfumes.

The following references disclose a wide variety of perfumes U.S. Pat. No. 3,983,079; U.S. Pat. No. 4,105,573; U.S. Pat. No. 4,219,436; U.S. Pat. No. 4,339,356; U.S. Pat. No. 4,515,705; U.S. Pat. No. 4,714,562; U.S. Pat. No. 4,740,327; U.S. Pat. No. 4,933,101; U.S. Pat. No. 5,061,393; U.S. Pat. No. 5,066,419; U.S. Pat. No. 5,154,842; U.S. Pat. No. 5,232,613; U.S. Pat. No. 5,500,154; U.S. Pat. No. 5,670,475; U.S. Pat. No. 6,143,707; and U.S. Pat. No. 6,194,362.

Carrier Medium

Any suitable carrier medium in any suitable amount may be used to make the rinse aid composition. Suitable carrier mediums include both liquids and solids. Several non-limiting examples of types of carrier mediums are provided by way of explanation, and not by way of limitation. In one example, the rinse aid composition can be provided in the form of an aqueous liquid in a container. In another example, the rinse aid composition may exist in a solid form in a container and the solid could be dissolved with water. In another example, the rinse aid composition can be provided in the form of a combination of both a liquid and a solid that can be diluted or dissolved with water. In one non-limiting embodiment, the form of the rinse aid composition can be a dry powder, granule or tablet, encapsulated product, and combinations thereof.

One suitable carrier medium may be water, which can be distilled, deionized, or tap water. Water may be preferred due to its low cost, availability, safety, and compatibility. In other non-limiting embodiments the carrier medium may be tap water.

In one non-limiting embodiment in which the carrier medium may be aqueous, at least some of the aqueous carrier may be purified beyond the treatment it received to convert it to tap water (that is, the tap water may be post-treated, e.g., deionized or distilled). In yet another non-limiting embodiment at least some of the carrier may be hard water having a hardness of at least 3.3 mM (Calcium:Magnesium=3:1).

Optionally, in addition to water, the carrier can contain a low molecular weight organic solvent that may be highly soluble in water, e.g., ethanol, methanol, propanol, isopropanol and the like, and mixtures thereof. Low molecular weight alcohols can allow the treated dish- and glassware surface to dry faster. The optional water-soluble low molecular weight solvent can also be used at a level of up to about 50%, typically from about 0.1% to about 25%, alternatively from about 2% to about 15%, alternatively from about 5% to about 10%, by weight of the suitable carrier medium.

Factors that need to be considered when a high level of solvent is combined with the suitable carrier medium are odor, flammability, dispersancy and environment impact.

Rinse aid compositions can also be in a “concentrated form”, in such case, the concentrated liquid rinse aid composition according one non-limiting embodiment will contain a lower amount of a suitable carrier medium, compared to conventional liquid rinse aid compositions. For example, the suitable carrier medium content of the concentrated system may, for example, be present in an amount from about 30% to about 99.99% by weight of the rinse aid composition. The dispersant content of the concentrated system rinse aid composition may, for example, be present in an amount from about 0.001% to about 10% by weight of the rinse aid composition.

Binder

The solid rinse aid compositions may also contain any suitable binder in any suitable amount. The binding agent of the solid rinse aid composition holds the dry components together in a single mass. The binding agent may comprise any material which is relatively high melting and which will maintain product integrity.

Suitable binders include, but are not limited to, materials such as nonionic surfactants, polyethylene glycols, anionic surfactants, film forming polymers, fatty acids, and mixtures thereof, wherein the binder does not melt below 40° C., as disclosed in U.S. Pat. No. 4,486,327, Murphy et al, issued Dec. 4, 1984. In certain embodiments, certain binders include alkali metal phosphates, fatty amides, and combinations thereof.

Suitable binders, for example, may be optionally incorporated in the rinse aid composition at a level of from about 0.05% to about 98%, alternatively from about 0.05% to 70%, alternatively from about 0.05% to 50%, alternatively from about 0.05% to 30%, alternatively from about 0.05% to 10%, and alternatively from 0.1% to 5% by weight of the total composition. Filler materials can also be present in the rinse aid composition. These may include sucrose, sucrose esters, alkali metal chlorides or sulfates, in amounts from 0.001% to 60%, and alternatively from 5% to 30% of the composition.

Hydrotrope

Any suitable hydrotrope in any suitable amount may be used to make the rinse aid composition. Suitable hydrotropes include, but are not limited to, sodium benzene sulfonate, sodium toluene sulfonate, sodium cumene sulfonate, and mixtures thereof.

The following references disclose a wide variety of suitable hydrotropes: U.S. Pat. No. 6,130,194; U.S. Pat. No. 5,942,485; U.S. Pat. No. 5,478,503; U.S. Pat. No. 5,478,502; U.S. Pat. No. 6,482,786; U.S. Pat. No. 6,218,345; U.S. Pat. No. 6,191,083; U.S. Pat. No. 6,162,778; U.S. Pat. No. 6,152,152; U.S. Pat. No. 5,540,865; U.S. Pat. No. 5,342,549; U.S. Pat. No. 4,966,724; U.S. Pat. No. 4,438,024; and U.S. Pat. No. 3,933,671.

### Product Form

The rinse aid composition may be used in any variety of product forms, including, but not limited to, liquid, gel, solid, granular, powder, and combinations thereof. In one non-limiting embodiment, the rinse aid composition may be formulated as a solid to deliver a water-soluble metal salt to the rinse without excessive precipitation. In another non-limiting embodiment, the rinse aid composition comprising water-soluble metal salt in the form of a solid, which could be designed to delay release of the water-soluble metal salt until the rinse cycle.

The rinse aid composition in any physical form (e.g. liquid, gel, solid, granular, powder, and combinations thereof) may be packaged in a water-soluble or water dispersible pouch, and combinations thereof, to deliver the water-soluble metal salt to the rinse liquor. The rinse aid composition can be in the form of a unit dose, which allows for the controlled release (for example delayed, sustained, triggered or slow release) of the water-soluble metal salt during the rinse cycle of an automatic dishwashing appliance.

Single- and multi-compartment water-soluble pouches may be suitable for use. In the case of additive and multi-component products, the rinse aid compositions do not need to be in the same physical form. In another non-limiting embodiment, the rinse aid composition may be formulated in a multi-compartmental pouch so that negative interactions with other rinse aid components are minimized.

In yet another embodiment, rinse aid compositions suitable for use can be dispensed from any suitable device, such as bottles (pump assisted bottles, squeeze bottles), paste dispensers, capsules, multi-compartment bottles, multi-compartment capsules, and single- and multi-compartment water-soluble pouches, and combinations thereof.

In another non-limiting embodiment, the rinse aid composition can be in the form of a unit dose which allows for the controlled release (for example delayed, sustained, triggered or slow release) of the water-soluble metal salt during the rinse cycle of an automatic dishwashing appliance. In unit dose forms, for example, the rinse aid composition may be a solid, granular, powder, liquid, gel, and combinations thereof, and may be provided as a tablet or contained in a single or multi-compartment water-soluble pouch.

### Method of Use

In one non-limiting embodiment, a method of rinsing cleaned glassware may comprise rinsing the cleaned glassware in an automatic dishwashing machine with a rinse aid composition comprising: (a) at least one water-soluble metal salt; (b) an acid; (c) a non-ionic surfactant; (d) at least one of the following: a dispersant polymer, a perfume, and mixtures thereof, and (e) optionally at least one component selected from the group consisting of acid, dispersant polymer, perfume, hydrotrope, binder, carrier medium, antibacterial active, dye, and mixtures thereof. The rinse aid composition has a pH of less than about 5 when measured at a 10% concentration in an aqueous solution.

In another non-limiting embodiment, a method of rinsing cleaned glassware is disclosed wherein the acid enables the water-soluble metal salt to dissolve quickly in the rinse liquor of an automatic dishwashing appliance so as to minimize formation of insoluble precipitates on glassware.

The rinse aid composition disclosed in the above methods may be present in any form including, but not limited to, liquid, gel, solid, granular, powder, and combinations thereof. The rinse aid composition may, for example, deliver from about 0.01 mM to about 10 mM, alternatively about 0.02 mM to about 5 mM, alternatively about 0.05 mM to about 1 mM, and alternatively about 0.05 mM to about 0.5 mM of the water-soluble metal salt in the rinse liquor during the rinse cycle. The water-soluble metal salt may be in the form of a powder, crystal, core particle, aggregate of core particles, prill, agglomerate, and mixtures thereof and as such may be nonfriable, water-soluble or water dispersible or which dissolve, disperse or melt in a temperature range of from about 40° C. to about 50° C.

### Kit

In one non-limiting embodiment, a kit may comprise (a) a package, (b) instructions for use, and (c) a rinse aid composition suitable for use in automatic dishwashing comprising (i) a water-soluble metal salt comprising aluminum, zinc, magnesium, calcium, lanthanum, tin, gallium, strontium, titanium, and combinations thereof, (ii) an acid; (iii) a non-ionic surfactant; (iv) at least one of the following: a dispersant polymer, perfume, and mixtures thereof, and (v) optionally at least one component selected from the group consisting of hydrotrope, binder, carrier medium, antibacterial active, dye, and mixtures thereof. The rinse aid composition may, for example, deliver from about 0.01 mM to about 10 mM, alternatively about 0.02 mM to about 5 mM, alternatively about 0.05 mM to about 1 mM, and alternatively about 0.05 mM to about 0.5 mM of the water-soluble metal salt in the rinse liquor during the rinse cycle. The water-soluble metal salt may be in the form of a powder, crystal, core particle, aggregate of core particles, prill, agglomerate, and mixtures thereof and may be nonfriable, water-soluble or water dispersible or which dissolve, disperse or melt in a temperature range of from about 40° C. to about 50° C. The rinse aid composition may be a liquid, gel, solid, granular, powder, and combinations thereof, and may be provided as a tablet or contained in a single or multi-compartment water-soluble pouch.

| | FORMULA | | | | | |
|---|---|---|---|---|---|---|
| | A | B | C | D | E | F |
| Nonionic | 35.0 | 35.0 | 35.0 | 35.0 | 20.0 | Jet- |
| surfactant | | | | | | Dry ® |
| ZnCl2 | 4.0 | 4.0 | — | — | 5.0 | Rinse |
| Zn(NO3)2* | — | — | 5.6 | — | — | Aid |
| Acid | — | 1.2 | 1.56 | 1.2 | — | |
| Chelating agent | — | — | — | — | 20.0 | |
| Polymer | — | — | 4.0 | — | — | |
| dispersant | | | | | | |
| Perfume | 0.12 | 0.12 | 0.12 | 0.12 | — | |
| Water/hydrotrope | Balance | Balance | Balance | Balance | Balance | |
| system | | | | | | |
| 10% pH | 6.5 | 2.6 | 2.6 | 2.8 | 1.9 | |
| FILMING | | | | | | |
| PERFORMANCE | | | | | | |
| Test 1 (soft water) | Yes | No | No | — | Yes | — |
| Crystal/film | | | | | | |
| present on | | | | | | |
| glasses? | | | | | | |
| Test 2 (21 gpg | — | 4.6E** | 4.2E** | — | | 3.1 |
| hardness) | | | | | | |
| Film grade (1-10, | | | | | | |
| 10 = best) | | | | | | |
| Test 3 (21 gpg | — | 4.7D*** | — | 3.4 | — | — |
| hardness) | | | | | | |
| Film grade (1-10, | | | | | | |
| 10 = best) | | | | | | |

*Formed in situ by reacting ZnO and nitric acid.
**E means formula B or C has significantly less film than formula E.
***D means formula B has significant less film than formula D.

Formulas B and C are non-limiting examples of formulations according to this invention. Formulas A, D, E and F are formulas of commercially available products and are provided for filming performance comparison.

Filming performance measurements of test formulas are obtained using a GE500 automatic dishwashing appliance and with the use of CASCADE™ Pure Rinse Gel®, the leading commercial automatic dishwashing liquid gel, as the main wash detergent at recommended dosages. A unit dosage of 2 ml of each rinse aid formula (A,B,C,D,E, or F) is added to the final rinse cycle. At the end of the dry cycle, the glasses are either imaged for visible inspection or for statistical evaluation.

Test 1 is run in soft water. Both formula A (pH>5) and formula E (with 20% chelating agent) exhibit visible crystals and film formation on glassware while formulas B and C exhibit neither visible crystals nor film formation on the glassware.

Test 2 is run in hard water (21 gpg Ca/Mg 3:1 ratio). Formulas B and C contain a water-soluble zinc salt compound and/or a polymer dispersant and perform significantly better than formula F, Jet-Dry®, (i.e., significantly less film on glassware).

Test 3 is also run in hard water (21 gpg Ca/Mg 3:1 ratio). Formula B contains a water-soluble zinc salt compound and performs significantly better (i.e., significantly less film) than formula D (without the zinc compound).

The foregoing description can be provided to enable any person skilled in the art to make and use the invention, and can be provided in the context of a particular application and its requirements. Various modifications to the embodiments will be readily apparent to those skilled in the art, and the generic principles defined herein can be applied to other embodiments and applications without departing from the spirit and scope of the invention. The possible embodiments of this invention are not intended to be limited to the embodiments shown. Thus, since the following specific embodiments are intended only to exemplify, but in no way limit, the operation of the present invention, the present invention is to be accorded the widest scope consistent with the principles, features and teachings disclosed herein.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document can be not to be construed as an admission that it can be prior art with respect to the present invention.

What is claimed is:

1. A rinse aid composition for reducing glassware corrosion comprising:
a) at least one water-soluble metal salt;
b) an acid;
c) a non-ionic surfactant;
d) at least one of the following: a dispersant polymer, a perfume, and mixtures thereof, and
e) optionally at least one component selected from the group consisting of acid, dispersant polymer, perfume, hydrotrope, binder, carrier medium, antibacterial active, dye, and mixtures thereof;
wherein said rinse aid composition has a pH of less than about 5 when measured at a 10% concentration in an aqueous solution.

2. A rinse aid composition according to claim 1, wherein said composition is in the form of a liquid, liquid, gel, solid, granular, powder, and combinations thereof.

3. A rinse aid composition according to claim 1, wherein said rinse aid composition delivers from about 0.01 mm to about 10 mm of said at least one water-soluble metal salt in the rinse liquor.

4. A rinse aid composition according to claim 3, wherein said rinse aid composition delivers from about 0.02 mM to about 5 mM of said at least one water-soluble metal salt in the rinse liquor.

5. A rinse aid composition according to claim 1, wherein said effective amount of said at least one water-soluble metal salt is from about 0.01% to about 70% by weight of the composition.

6. A rinse aid composition according to claim 1, wherein said at least one water-soluble metal salt comprises a metal selected from the group consisting of aluminum, zinc, magnesium, calcium, lanthanum, tin, gallium, strontium, titanium, and mixtures thereof.

7. A rinse aid composition according to claim 6, wherein said metal in said water-soluble metal salt is zinc.

8. A rinse aid composition according to claim 7, wherein said water-soluble zinc salt is selected from the group consisting of zinc acetate, zinc chloride, zinc gluconate, zinc formate, zinc malate, zinc nitrate, zinc sulfate, and mixtures thereof.

9. A rinse aid composition according to claim 8, wherein said water-soluble zinc salt is zinc chloride.

10. A rinse aid composition according to claim 8, wherein said water-soluble zinc salt is zinc gluconate.

11. A rinse aid composition according to claim 8, wherein said water-soluble zinc salt is zinc nitrate.

12. A rinse aid composition according to claim 8, wherein said water-soluble zinc salt is zinc sulfate.

13. A rinse aid composition according to claim 1, wherein said acid is present from about 0.01% to about 25% by weight of the composition.

14. A rinse aid composition according to claim 1, wherein said acid is selected from the group consisting of organic, inorganic, and mixtures thereof.

15. A rinse aid composition according to claim 14, wherein said acid is selected from the group consisting of acetic acid, aspartic acid, benzoic acid, boric acid, bromic acid, citric acid, formic acid, gluconic acid, glutamic acid, hydrochloric acid, lactic acid, malic acid, nitric acid, sulfamic acid, sulfuric acid, tartaric acid, and mixtures thereof.

16. A rinse aid composition according to claim 15, wherein said acid is nitric acid.

17. A rinse aid composition according to claim 15, wherein said acid is hydrochloric acid.

18. A rinse aid composition according to claim 15, wherein said acid is citric acid.

19. A rinse aid composition according to claim 1, wherein said pH is in the range of from about 1 to about 4.

20. A rinse aid composition according to claim 1, wherein said dispersant polymer comprises at least one or more homopolymer, copolymer, terpolymer, and mixtures thereof.

21. A rinse aid composition according to claim 1, wherein said dispersant polymer is a low molecular weight polyacrylate dispersant polymer having a molecular weight of less than about 15,000 and is the non-neutralized form of the polymer comprising about 70% by weight acrylic acid and about 30% by weight methacrylic acid.

22. A rinse aid composition according to claim 21, wherein said molecular weight is from about 500 to about 10,000.

23. A rinse aid composition according to claim 22, wherein said molecular weight is about 3500.

24. A rinse aid composition according to claim 1, wherein said dispersant polymer is a low molecular weight modified polyacrylate copolymer, wherein said copolymer contains as monomer units:
a) from about 90% to about 10% by weight acrylic acid or its salts, and
b) from about 10% to about 90% by weight of a substituted acrylic monomer or its salt and have the general formula:
—[(C(R²)C(R¹)(C(O)OR³)]—
wherein the incomplete valencies inside the square braces are hydrogen and at least one of the substituents R¹, R² or R³ is a 1 to 4 carbon alkyl or hydroxyalkyl group, and wherein R¹ or R² can be a hydrogen and R³ can be a hydrogen or alkali metal salt.

25. A rinse aid composition according to claim 24, wherein said incomplete valencies inside the square braces are hydrogen and at least one of the substituents R¹ or R² is a 1 to 4 carbon alkyl or hydroxyalkyl group.

26. A rinse aid composition according to claim 24, wherein said dispersant polymer is a substituted acrylic monomer, and wherein R¹ is methyl, R² is hydrogen and R³ is sodium.

27. A rinse aid composition according to claim 2, wherein said composition is a solid; and wherein said water-soluble metal salt is in the form of a powder, crystal, core particle, aggregate of core particles, prill, agglomerate, and mixtures thereof.

28. A rinse aid composition according to claim 1, wherein said acid enables said metal salt to dissolve quickly in the rinse liquor of an automatic dishwashing appliance so as to minimize formation of insoluble precipitates on hard surfaces.

29. A rinse aid composition according to claim 1, wherein said composition further comprises at least one component selected from the group consisting of hydrotrope, binder, dispersant polymer, perfume, carrier medium, antibacterial active, dye, and mixtures thereof.

30. A method of rinsing cleaned glassware comprising the step of rinsing said cleaned glassware in an automatic dishwashing machine with a rinse aid composition comprising:
a) at least one water-soluble metal salt;
b) an acid;
c) a non-ionic surfactant;
d) at least one of the following: a dispersant polymer, a perfume, and mixtures thereof; and
e) optionally at least one component selected from the group consisting of acid, dispersant polymer, perfume, hydrotrope, binder, carrier medium, antibacterial active, dye, and mixtures thereof;
wherein said rinse aid composition has a pH of less than about 5 when measured at a 10% concentration in an aqueous solution.

31. A method according to claim 30 wherein from about 0.01 mM to about 10 mM of said at least one water-soluble metal salt is delivered to the rinse liquor of an automatic dishwashing appliance during operation.

32. A method according to claim 30, wherein said effective amount of at least one water-soluble metal salt comprises from about 0.01% and about 70% by weight of the composition.

33. A method according to claim 30, wherein said effective amount of said non-ionic surfactant comprises from about 0.01% to about 60% by weight of the composition.

34. A method according to claim 30, wherein said composition further comprises at least one component selected from the group consisting of hydrotrope, binder, dispersant polymer, perfume, carrier medium, antibacterial active, dye, and mixtures thereof.

35. A kit reducing glassware corrosion and film formation in an automatic dishwashing process comprising: (a) a package, (b) instructions for use and (c) a rinse aid composition suitable for use in automatic dishwashing comprising (i) a water-soluble metal salt comprising aluminum, zinc, magnesium, calcium, lanthanum, tin, gallium, strontium, titanium, and combinations thereof; (ii) an acid; (iii) a non-ionic surfactant; (iv) at least one of the following: a dispersant polymer, a perfume, and mixtures thereof; and (v) optionally at least one component selected from the group consisting of hydrotrope, binder, carrier medium, antibacterial active, dye, and mixtures thereof.

36. A method of reducing glassware corrosion and film formation in an automatic dishwashing process, wherein said method comprises the step of rinsing cleaned glassware with a rinse aid composition comprising:
(a) at least one water-soluble metal salt;
(b) a non-ionic surfactant; and
(c) at least one component selected from the group consisting of acid, hydrotrope, binder, dispersant polymer, perfume, carrier medium, antibacterial active, dye, and mixtures thereof; and
wherein said rinse aid composition has a pH of less than about 5 when measured at a 10% concentration in an aqueous solution, and wherein said composition.
